(19) United States
(12) Patent Application Publication
(10) Pub. No.: US 2026/0337097 A1
(43) Pub. Date: Oct. 29, 2026

(54) A Method For The Production Of A Hydraulic Binder

(71) Applicant: ECOSCITEC INNOVATIONS PTY LTD, QLD (AU)

(72) Inventor: Duncan HYWEL-EVANS, QLD (AU)

(73) Assignee: ECOSCITEC INNOVATIONS PTY LTD, QLD (AU)

(21) Appl. No.: 19/104,080

(22) PCT Filed: Jul. 28, 2023
(86) PCT No.: PCT/AU2023/050710

§ 371 Date: Feb. 14, 2025

(30) Foreign Application Priority Data
Aug. 17, 2022 (AU) 2022902329

(51) Int. Cl. C04B 7/153; C04B 7/32; C04B 28/06; C04B 28/08

(52) U.S. Cl. CPC C04B 7/153; C04B 7/323; C04B 28/065; C04B 28/082

(57) ABSTRACT

A method for the production of a hydraulic binder comprising:
introducing a source of aluminium to a body of water to produce aluminium hydroxide;
introducing an ion source, in the form of a slag, to the body of water, the source configured to release a plurality of ions into the body of water;
introducing a counterion source to the body of water, the counterion source configured to release a plurality of counterions into the body of water;
converting at least a portion of the aluminium hydroxide at least a portion of the plurality of counterions and/or at least a portion of the plurality of ions to a crystalline AFt phase; and
converting at least a portion of the crystalline AFt phase using at least a portion of the plurality of ions to a crystalline AFm phase, wherein the crystalline AFm phase and/or the crystalline AFt phase forms the hydraulic binder.

### TECHNICAL FIELD

The present invention relates to method for the production of a hydraulic binder. In particular, the present invention relates to a hydraulic binder produced through an improved cement hydration mechanism.

### BACKGROUND

Portland cement is the most common type of hydraulic binder in general use around the world as a basic ingredient of concrete, mortar, stucco, and non-specialty grout. The widespread use of Portland cement is due, at least in part, to the low cost and ready availability of the materials from which it is manufactured.

However, in recent times, the ongoing and expanded use of Portland cement has been called into question due to its energy intensive manufacturing process. Further, the production of each tonne of Portland cement clinker generates an average of 843 kg of carbon dioxide, raising concerns about the environmental sustainability of the product.

An essential step in the Portland cement utilisation process is a hydration step. Portland cement powder is dissolved in water to produce hydration products in the form of calcium hydroxide (CH) and calcium silicate hydrate (CSH) at a pH of approximately 13.5. Not only is CSH of variable composition, as with calcium hydrate (CH), it is also reactive with carbon dioxide and salts in the environment. This reaction with carbon dioxides and salts has the effect of destabilising the hydration products, such that the CSH and CH are no longer environmentally stable. As a result of this reduction in stability, hydrated Portland cement can suffer from significant reductions in its performance (due to decomposition) over a relatively short period of time.

Some attempts have been made to overcome the carbon dioxide burden drawback. For instance, alternative hydraulic binders, such as geopolymer cements (which typically combined an aluminium silicate with a chemical activator), have been used as a more environmentally friendly alternative to Portland cement. However, these geopolymer cements often display poorer mechanical properties than Portland cement and are prone to higher degradation rates with decomposition mechanisms accelerated by the remnants of the geopolymer activation process.

In light of the foregoing, there would be an advantage if it were possible to provide an improved hydraulic binder and method of manufacturing thereof that produced a product having improved mechanical properties and environmental stability, while also being more environmentally friendly than Portland cement.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a method for the production of a hydraulic binder, which may at least partially address one or more of the problems or deficiencies mentioned above or which may provide the public with a useful or commercial choice.

According to a first aspect of the present invention there is provided a method for the production of a hydraulic binder comprising:
introducing a source of aluminium to a body of water to produce aluminium hydroxide;
introducing an ion source, in the form of a slag, to the body of water, the source configured to release a plurality of ions into the body of water;
introducing a counterion source to the body of water, the counterion source configured to release a plurality of counterions into the body of water;
converting at least a portion of the aluminium hydroxide at least a portion of the plurality of counterions and/or at least a portion of the plurality of ions to a crystalline AFt phase; and
converting at least a portion of the crystalline AFt phase using at least a portion of the plurality of ions to a crystalline AFm phase, wherein the crystalline AFm phase and/or the crystalline AFt phase forms the hydraulic binder.

It will be understood that the term “AFt phase” is an abbreviation for “alumina, ferric oxide, tri-counterion” or (Al₂O₃—Fe₂O₃-tri). The term represents a group of calcium sulfoaluminate hydrates. AFt phases have the general formula [Ca₃(Al,Fe)(OH)₆·12H₂O]₂·X₃·nH₂O where X represents a charged anion (X in this case denoting sulfate). Ettringite is a common member of the AFt group and is the name of the mineralogical supergroup to which all AFt's belong.

It will be understood that the term “AFm phase” is an abbreviation for “alumina, ferric oxide, mono-counterion” or (Al₂O₃—Fe₂O₃-mono). It represents another group of calcium aluminate hydrates with general formula [Ca₂(Al,Fe)(OH)₆]₂·X·nH₂O where X represents a lone charged anion. X may be one of many anions, with common anions including hydroxyl, sulfate and carbonate.

It will be understood that the method of the present invention is performed in the absence of Portland cement.

The source of aluminium may be of any suitable form. For instance, the source of aluminium may comprise a single material, or may comprise two or more materials. Preferably, the source of aluminium may be an inorganic material. More preferably, the source of aluminium may comprise one or more water soluble ionic compounds. The source of aluminium may comprise one or more silicates, oxides, sulphates, sulfides (or other soluble sulphur-containing compounds), hydroxides, carbonates, chlorides or the like, or any suitable combination thereof. Thus, it is envisaged that the aluminium may introduce aluminium cations into the body of water.

In some embodiments of the invention, a source of calcium may also be introduced to the body of water. The source of calcium may be of any suitable form. For instance, the source of calcium may comprise a single material, or may comprise two or more materials. Preferably, the source of aluminium may be an inorganic material. More preferably, the source of calcium may comprise one or more water soluble ionic compounds. The source of calcium may comprise one or more silicates, oxides, sulphates, sulfides (or other soluble sulphur-containing compounds), hydroxides, bromides, iodides, chlorides, acetates or the like, or any suitable combination thereof. Thus, it is envisaged that the calcium may introduce calcium cations into the body of water.

It is envisaged that, in the present invention, the depletion of the pore solution calcium may drive the dissolution of the pozzolan materials. Specifically, the depletion of the solution at a relatively low pH (compared to conventional Portland cement processes) draws ions from the raw materials introduced to the body of water.

In some embodiments of the invention, the source of aluminium and the source of calcium may comprise different compounds. Alternatively, the source of aluminium and the source of calcium may be the same compound. In this embodiment, the compound may be of any suitable type, such as, but not limited to, an aluminium calcium silicate, an aluminium calcium oxide, an aluminium calcium halide, an aluminium calcium hydroxide, an aluminium calcium chloride, an aluminium calcium sulfide, an aluminium calcium sulphate or the like, or any suitable combination thereof.

As previously stated, an ion source, in the form of a slag, is introduced to the body of water. In a specific embodiment, the slag may comprise a slag produced from a steel manufacturing process, such as slag produced in a basic oxygen furnace (BOF). Thus, the slag may be a steel slag.

It is estimated that between 190 and 280 million tonnes of steel slag is generated per year. Steel slag is considered to be a waste product, and there is estimated to be 2 billion tonnes of steel slag in landfill around the world. In some cases, instead of being sent to landfill steel slag is cast and crushed to form a road base material. However, the leaching of metals from steel slag, leading to the production of toxic run off, can occur, thereby creating environmental problems.

By using steel slag as an ion source in the present invention, it is envisaged that a significant global waste product may be used to produce an environmentally-friendly hydraulic binder (using relatively low energy), the production of which significantly reduces carbon emissions in comparison to conventional Portland cement production processes.

In some embodiments of the invention, the slag may undergo a size reduction process prior to being introduced to the body of water. Any suitable size reduction technique may be used, such as, but not limited to, crushing, grinding or the like.

The slag may be reduced to any suitable particle size. For instance, the average particle size of the slag following the size reduction process may be less than 100 mm. In other embodiments of the invention, the average particle size of the slag following the size reduction process may be less than 50 mm. In other embodiments of the invention, the average particle size of the slag following the size reduction process may be less than 10 mm.

Preferably, the slag may be combined with a calcium sulphoaluminate cement or a calcium aluminate cement prior to being introduced to the body of water. The slag may be subject to a size reduction process prior to being combined with the calcium sulphoaluminate cement or the calcium aluminate cement prior to being introduced to the body of water.

The slag may be combined with the calcium sulphoaluminate cement or the calcium aluminate cement in any suitable proportions. For instance, the proportion of the slag in the combined slag and calcium sulphoaluminate cement or calcium aluminate cement may be between 1 wt % and 99 wt %. More preferably, the proportion of the slag in the combined slag and calcium sulphoaluminate cement or calcium aluminate cement may be between 10 wt % and 90 wt %. More preferably, the proportion of the slag in the combined slag and calcium sulphoaluminate cement or calcium aluminate cement may be between 25 wt % and 75 wt %.

In some embodiments of the invention, the ion source may comprise a source of aluminium ions. More preferably, the ion source may comprise a source of aluminium and calcium ions. Still more preferably, the ion source may comprise a source of aluminium, calcium and silicon ions. It is envisaged, however, that the slag may constitute a source of ions of a number of other elements, such as, but not limited to, gallium, manganese, tungsten, cadmium, chromium, strontium, cobalt, lead, nickel, barium, titanium, molybdenum, vanadium, selenium, arsenic, iodine, bromine, boron, chlorine and the like. Thus, in the present invention, the slag does not constitute a traditional cementitious agent, but is instead a “mineable” resource, in that ions from the slag may be recovered for use in the method of the present invention. It is envisaged that the ions of the other elements may be utilised in the method of the present invention to aid in the formation of the AFt phase.

It is envisaged that, in conventional processes, the ions of the other elements would not typically be utilised, as they either do not normally occur in the body of water at the onset of hydration, and/or are suppressed by their rate of reaction or excluded by more reactive/dominant ions. However, introducing these ions into the body of water before the usual hydration reactions occur results in the reactivity of the phase and the particle size has a relatively low effect on the hydration rate compared to processes using Portland cement.

It will be understood that slags such as steel slag are classed as having low reactivity. However, the reactions occurring in the method of the present invention are typically fast (and certainly faster than those in the hydration of Portland cement) even when the slag is not ground to a relatively small particle size.

In particular, it is envisaged that the present invention may comprise a sequence of reactions, in which one or more products from a previous reaction may be utilised. Thus, in some embodiments, the sequence of reactions may comprise a stepwise sequence of reactions.

The sequence of reactions may drive (or be manipulated to drive) a process in which less favourable ions (in terms of their reactivity or crystal-forming properties) may be released or scavenged from the ion source when the body of water becomes low in soluble ions. Thus, phases of the ion source that may have low reactivity may be effectively mined from the ion source to produce solute for the formation of other members of a solid solution series. For instance, a silicate counter ion may be extracted from a C₂S phase before normal hydration occurs, trapping atmospheric carbon dioxide as a counterion during the formation of the more stable but slower forming C₆ASS̅C̅ solid solution member, as opposed to the more rapidly formed three sulphate—aluminium solid solution member of an ettringite (C6ASSS) series which decomposes to calcium carbonate, aluminium hydroxide and calcium sulphate in the presence of atmospheric carbon dioxide.

The counterion source may be of any suitable form and may release counterions into the body of water in any suitable manner, such as by dissolving in the body of water. Preferably, however, the counterion source may comprise one or more water-soluble inorganic compounds. In this embodiment, the counterions may be released into the body of water by dissociation of the water-soluble inorganic compounds. It will be understood that the exact nature of the counterion source will depend on the counterions that are to be released into the body of water. For instance, if the desired positive counterions comprise sodium, the counterion source may comprise a water-soluble sodium compound (such as a sodium chloride, sodium oxide, sodium sulfate, sodium carbonate, sodium hydroxide or the like, or any suitable combination thereof). In some embodiments, the desired counterions may comprise sodium, potassium, calcium, iron, aluminium, copper, nickel, strontium, chromium, zinc ions or the like, or any suitable combination thereof. In a most preferred embodiment, the counterion source may comprise a source of calcium ions. In a preferred embodiment of the invention, a stoichiometric excess of calcium ions may be provided in order to drive the formation of the crystalline AFt phase.

The negative counterions provided by the counterion source may be of any suitable form, and it will be understood that the negative counterions may vary depending on the nature of the positive counterions, the nature of the source of aluminium (and the source of calcium, if present) and so on. Thus, it is envisaged that the negative counterions may comprise carbonate anions, chloride anions, oxide anions, sulfate anions, hydroxide anions and so on, or any suitable combination thereof.

The body of water may be of any suitable type, and it will be understood that the size and nature of the body of water will depend on the quantity of the crystalline AFt phase to be produced. Preferably, however, the body of water comprises a pool, vat, tank, pond, reservoir or the like. While the water in the body of water may be of any suitable form, it is preferred that, prior to the method of the present invention, the water may be relatively free from ions. In some embodiments of the invention, however, the water may include a quantity of the counterions. While the water may be of any suitable pH, it is preferred that the water may be of a relatively neutral pH, or a slightly basic pH (i.e., a pH of between 7 and approximately 9).

In some embodiments of the invention, one or more reactants may be added to the body of water. The one or more reactants may be of any suitable form, and those skilled in the art will understand that the addition of the one or more reactants (as well as the quantity of the one or more reactants used) will be dependent on the nature and composition of the other components of the method and so on.

In some embodiments of the invention, the one or more reactants may comprise one or more of a plasticiser, a retarder and an accelerator. Any suitable substance may be used as the plasticiser, retarder and accelerator. However, in one embodiment of the invention, the plasticiser may comprise calcium naphthalenesulphonate. In one embodiment, the retarder may comprise an acid, and in particular citric acid. In one embodiment, the accelerator may comprise lithium carbonate and, in particular, relatively fine lithium carbonate.

It is envisaged that the aluminium hydroxide produced from the source of aluminium may be produced in any suitable manner. Preferably, however, the aluminium hydroxide may be produced as a precipitate. More specifically, the aluminium hydroxide may be precipitated as aluminium hydroxide gel. By way of further explanation, it is envisaged that the aluminium hydroxide that is formed precipitates out of solution as an amorphous semi soluble polymer, which then combines with calcium to form a hydrated ion pair. The formation of this ion pair is the reason for the growth of the AFt phase as an elongate, acicular crystal. Typically, at the base of the AFt crystal, there is a catalyst which is insoluble and provides a charged surface on which the AFt is co-ordinated. Further calcium aluminium ion pairs are inserted at the base of the crystal, effectively pushing up or growing the crystal from the base.

Any suitable reaction may be used to precipitate aluminium hydroxide from solution. A specific example of an aluminium hydroxide precipitation reaction (involving aluminium chloride, sodium carbonate and water) is set out below:

2AlCl₃+3Na₂CO₃+3H₂O→2Al(OH)₃+3CO₂+6NaCl

Typically, the conversion of aluminium cations to aluminium hydroxide gel is a relatively fast process. In addition, in comparison to the production of CSH in the conventional Portland cement hydration process (which occurs at a pH of 13.5), the precipitation of aluminium hydroxide gel occurs at a pH of approximately 8.

As previously stated, at least a portion of the aluminium hydroxide, at least a portion of the ions and at least a portion of the plurality of counterions are converted to a crystalline AFt phase. The at least a portion of the aluminium hydroxide, the at least a portion of the ions and the at least a portion of the plurality of counterions may be converted to any suitable crystalline AFt phase, although in a preferred embodiment of the invention, the at least a portion of the aluminium hydroxide, the at least a portion of the ions and the at least a portion of the plurality of counterions may be converted to ettringite. In this embodiment, the compound may be of the general form:

(CaO)₆(Al₂O₃)(SO₃)₃·32H₂O

or

(CaO)₃(Al₂O₃)(CaSO₄)₃·32H₂O.

The aluminium hydroxide, the at least a portion of the ions and the at least a portion of the plurality of counterions may be converted to the crystalline AFt phase using any suitable technique. Preferably, however, the aluminium hydroxide, the at least a portion of the ions and the at least a portion of the plurality of counterions are converted to the crystalline AFt phase via a hydration mechanism. It is envisaged that the crystalline AFt phase may absorb a relatively large amount of water from the body of water such that the crystalline AFt phase has a relatively high water content.

The crystalline AFt phase may have any suitable crystalline structure. For instance, the crystalline AFt phase may have a triclinic, monoclinic, orthorhombic, tetragonal, trigonal, hexagonal or cubic crystalline structure, or any suitable combination thereof. Preferably, however, the crystalline AFt phase may have a relatively elongate (or acicular) morphology. Preferably, the crystalline AFt phase has a relatively high water content.

As previously stated, at least a portion of the crystalline AFt phase is converted to a crystalline AFm phase. This may be achieved using any suitable technique. However, in a preferred embodiment of the invention, it is envisaged that the conversion of the crystalline AFt phase to the crystalline AFm phase may be driven, at least in part, by the dehydration of the body of water during the formation of the crystalline AFt phase. More specifically, as water is consumed during the formation of the crystalline AFt phase, a reduction in the available water then assists in the conversion of the crystalline AFt phase to the crystalline AFm phase.

As previously stated, the conversion of the crystalline AFt phase to the crystalline AFm phase is performed in the presence of the ion source. In a preferred embodiment of the invention, the ion source may be provided in order to drive the formation of the crystalline AFt phase and/or the crystalline AFm phase.

In conventional processes, environmental substances (such as salts, carbon dioxide and the like) may be attracted to the process and may react to degrade or decompose the reaction products. In the present invention, however, not only are the reaction products (the crystalline AFt phase and the crystalline AFm phase) substantially non-reactive with environmental substances, but the environmental substances may react to assist in the formation of the crystalline AFt phase and/or the crystalline AFm phase. Thus, not only do the environmental substances not have a detrimental effect on the present invention, but they may also increase the formation of the crystalline AFt phase and/or the crystalline AFm phase.

The crystalline AFm phase may be of any suitable form. In a preferred embodiment of the invention, the crystalline AFm phase may comprise a combination of mono carbonate, mono sulphate and gehlenite hydrate (C₂ASH₈).

It is envisaged that the crystalline AFt phase may be a rapidly forming, thermodynamically-unstable crystalline hydrate. The crystalline AFt phase may include an elongated morphology and may have a high water content. However, it is envisaged that the crystalline AFt phase may form a dispersed non-contiguous support structure that, preferably, defines the initial dimensions of the cement product and, in particular, the cement product once set.

Thus, it is envisaged that the crystalline AFt phase may form a frame structure or scaffold where the crystalline AFm phase may form.

As previously stated, it is envisaged that the formation of the crystalline AFt phase may consume large quantities of water. Thus, the hydration of the crystalline AFt phase assists in the conversion of at least a portion of the crystalline AFt phase by dehydrating unbound pore water to a point where the unavailability of water in the body of water slows or ceases the formation of the crystalline AFt phase, such that the reaction changes to the formation of the crystalline AFm phase. The mechanism of the formation of the crystalline AFm phase may include the sequential replacement of elements within the crystalline AFt phase and/or the counterions.

In some embodiments, the formation of the crystalline AFm phase may occur within the frame structure or scaffold of the crystalline AFt phase. It is envisaged that developing a contiguous crystalline matrix within the AFt frame structure places the AFt frame structure under dehydrating conditions. In turn, this may destabilise the AFt frame structure causing the AFt crystals to decompose to their base raw materials, freeing them for their consumption by the ongoing AFm hydration process.

The crystalline AFm phase may have any suitable crystalline structure. For instance, the crystalline AFm phase may have a triclinic, monoclinic, orthorhombic, tetragonal, trigonal, hexagonal or cubic crystalline structure, or any suitable combination thereof.

In essence, the present invention uses the AFt-AFm transition system to effectively mine the components of the hydration mixture (i.e., the body of water and the ion sources located therein) allowing the use of non-reactive materials to form hydrates having rapid strength gains which are also stable in the environment.

As previously stated, the hydraulic binder comprises the crystalline AFm phase and/or the crystalline AFt phase. In some embodiments, the hydraulic binder may comprise both the crystalline AFm phase and the crystalline AFt phase. In other embodiments, the hydraulic binder may comprise the crystalline AFm phase only.

In some embodiments, the AFt phase and the AFm phase may comprise only a single crystalline form of AFt and AFm. In other embodiments of the invention, the AFt phase and/or the AFm phase may comprise a plurality of crystalline forms of AFt and AFm. It will be understood that the different crystalline forms of the AFt and AFm phases may be of a different crystalline structure, different chemical composition and/or different stoichiometry to one another.

In some embodiments of the invention, the hydraulic binder may further comprise one or more anhydrite deposits. More specifically, the hydraulic binder may further comprise one or more botryoidal anhydrite deposits.

In a second aspect, the invention resides broadly in a hydraulic binder when formed by the method of the first aspect.

Advantageously, the present invention does not require the materials used to be cementitious or hydraulic. Instead, the present invention only requires a mechanism for the formation of AFt hydrates, and particularly AFt hydrate crystals, and that the materials used are at least somewhat soluble.

The present invention provides further advantages in that the initial pH of the invention is reduced in comparison to conventional methods, and that environmental substances (such as carbon dioxide, salt and the like) that are attracted to the method of the present invention may be consumed as counterions rather than causing decomposition or degradation or the hydration products.

Other advantages of the present invention include that the crystal structure of the hydraulic binder reduces or eliminates shrinkage of the hydraulic binder. Further, the fact that the hydraulic binder may be produced at a relatively weak basis pH not only makes the process safer, but also reduces the quantity of reagent required to generate the highly basic pH associated with conventional Portland cement production.

Additionally, the rate at which the strength of the hydraulic binder of the present invention is achieved is rapid in comparison to Portland cement. The rapid pace of the reactions to form the hydraulic binder means that at least 25% of the total 28 day strength of concrete formed using the hydraulic binder may be achieved in less than approximately 4 hours from the initial set, with between 60% and 70% of the total 28 day strength achieved within 24 hours. In some embodiments, a further hydration burst may occur at between 7 and 14 days from the initial set. It is envisaged that the further hydration burst may be associated with silicates in the hydraulic binder.

Further, the 28 day strength of hydraulic binders prepared according to the method of the present invention are considerable higher (approximately 2-2.5 times higher) than the 28 day strength of conventional concrete formed using Portland cement.

The fact that the hydraulic binder of the present invention achieves a high proportion of its total 28 day strength within a short period of time means that the hydraulic binder may also be used in applications where traditional cements have needed to be allowed to set and cure for a longer period of time before use. For instance, in the 3D printing of structures (such as houses and the like), a first layer of traditional cement product would be printed and then allowed to cure for a relatively lengthy period of time in order to achieve a sufficient proportion of the total 28 day strength before a second layer could be printed on top of the first layer.

In stark, contrast, the rapid setting and curing of the hydraulic binder of the present invention means that a second layer may be printed on top of a first layer a relatively short period of time after a first layer is printed. Thus, the overall speed of construction is increased, decreasing the time taken to construct a structure in comparison to conventional cement products.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### EXAMPLES

Two samples of Australian BOF steel slags (S500 and S502) were used to determine the efficiency by which a non-supersaturation reaction utilised steel slag in a stepwise hydration mechanism. In particular, the method was engineered to demonstrate the stepwise reaction mechanism of the present invention and to take advantage of the water diversion from AFt to AFm hydrates by manipulating water availability during the hydration reaction. In this way, the hydration products could be diverted towards more environmentally stable and natural compounds.

Steel slag S500 was of a controlled composition taken from the top of the molten steel within a crucible. Steel slag S502 was the remainder of the slag formed, containing material which had been ejected from the crucible during steel manufacture. It contained a high proportion of steel particles and iron oxide.

A grout containing each of the slags was formed, along with a control grout in which no slag was present (i.e., a conventional CSA cement grout). The grouts were of the compositions shown in Table 1.

TABLE 1

| | Slag Grout | Control Grout |
|---|---|---|
| Component | wt % | wt % |
| Pozzolan-Steel Slag | 46.78 | — |
| Cement-CSA | 23.39 | 23.39 |
| Pozzolan-Calcium sulphate | 7.80 | 7.80 |
| Plasticiser-Calcium | 1.77 | 1.77 |
| naphthalenesulphonate | | |
| Retarder-Citric Acid | 0.30 | 0.30 |
| Accelerator-Lithium carbonate | 0.15 | 0.15 |
| Sand-Dried 250-425 μm | 19.82 | 66.60 |

Each grout was then processed (with the slag grout being processed according to the method of the present invention) in order to produce a hydraulic binder that was subsequently air cured. The compressive strengths of the hydraulic binders were tested over a period of 28 days. The measured compressive strengths (in MPa)_are set out in Table 2.

TABLE 2

| Age | S500 Slag | S502 Slag | Control |
|---|---|---|---|
| 2 hours | 0.00 | 0.00 | 0.00 |
| 4 hours | — | 18.95 | 6.41 |
| 6 hours | 35.70 | — | — |
| 1 day | 39.82 | — | 31.19 |
| 2 days | — | 32.80 | — |
| 7 days | 53.98 | 42.98 | 22.50 |
| 14 days | — | 56.71 | — |
| 21 days | — | 61.77 | — |
| 28 days | 71.73 | 65.51 | 30.21 |

The results set out in Table 2 illustrate that the hydraulic binders produced according to the method of the present invention (i.e., those produced from slag) were both of significantly higher compressive strength to a conventional Portland cement hydraulic binder.

An analysis of the hydraulic binders produced from slag revealed a hydrate matrix comprising of acicular crystals forming a mesh. The crystals were ettringite crystals, composed of calcium aluminium and sulphate counterions. However, as the hydration progressed the ettringite crystals were replaced by solid solution members of the ettringite family with mixed counterions.

At later stages, the presence of AFm hydrates and acicular AFt crystals, as well as, in some instances, one or more anhydrite deposits (and, in particular, botryoidal anhydrite deposits).

Analysis of the acicular AFt crystals suggested the formulation of Ca₃(AlₙFe₁₋ₙ)(OH)₆(SO₄,SiO₄)×H₂O, having a similar formula to thaumasite.

In summary, in the method of the present invention, initial hydration produced AFt hydrates based on a calcium-aluminium backbone with sulphate as the counterion. Ettringite formation rapidly depleted the pore solution of both ions and water content, driving the AFt phase to scavenge ions from other sources (including the ion source, or slag). A proportion of the crystalline AFt phase (in the form of ettringite) formed contained counterions other than sulphate and formed the more stable AFt solid solution end members such as woodfordite.

Subsequently, crystalline AFt phases sequentially decomposed and reformed, resulting in a mechanistic change due to a restriction in available water. AFm hydrates initially formed based on calcium, aluminium and sulphate as the counterion. However, as more stable AFt phases containing ions other than sulphate decomposed, a range of AFm solid solution members began to be formed. Simultaneously, anhydrous phases of the original components ion source (i.e., the slag) and the counterion source continually placed ions into solution.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method for the production of a hydraulic binder according to an embodiment of the present invention.

FIG. 2 illustrates a schematic representation of a method for the production of a hydraulic binder according to an embodiment of the present invention.

### DETAILED DESCRIPTION

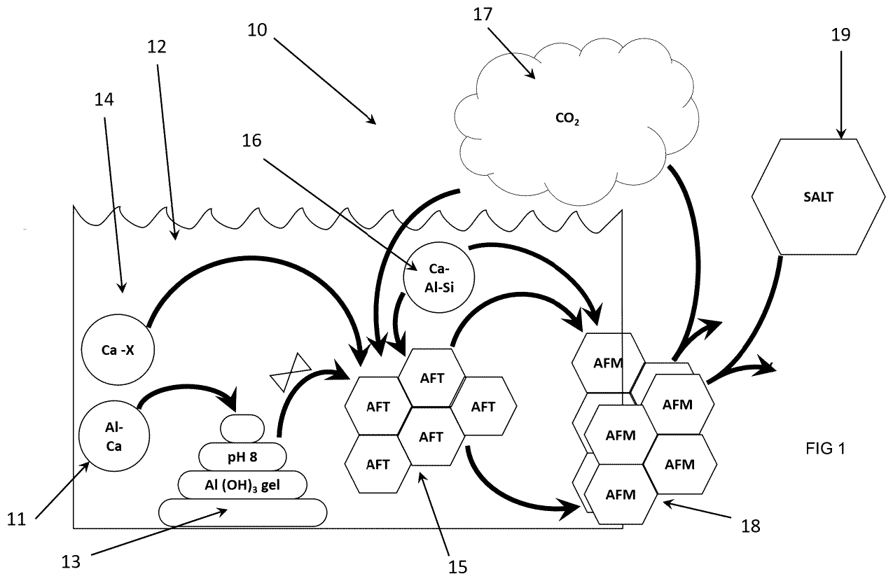

FIG. 1 illustrates a method 10 for the production of a hydraulic binder according to an embodiment of the present invention. In this embodiment, a source of aluminium 11 is introduced to a body of water 12. The source of aluminium 11 is also a source of calcium and may comprise any suitable soluble aluminium calcium inorganic compound. In the embodiment of the invention, the source of aluminium 11 comprises a calcium sulphoaluminate.

The dissociation of the inorganic compound comprising the source of aluminium 11 in the body of water generates a reaction between the aluminium ions and the water that results in the formation of aluminium hydroxide gel 13. The aluminium hydroxide gel 13 is produced at a pH of approximately 8, which is a considerably less alkaline pH than those experienced in the generation of CSH gel in the conventional Portland cement hydration process.

A counterion source 14 is also introduced to the body of water 12. In the embodiment of the invention shown in FIG. 1, the counterion source 14 is a soluble inorganic calcium compound, such as calcium nitrate, calcium sulfate, calcium acetate, calcium hydroxide, calcium chloride, calcium bromide or calcium iodide, or any combination thereof. The dissociation of the inorganic compound of the counterion source 14 introduces calcium cations and anions into the body of water 12.

An ion source 16, in the form of BOF steel slag, is also added to the body of water 12.

At least a portion of the aluminium hydroxide gel 13, at least a portion of the counterions produced from the counterion source 14, and at least a portion of the ions produced from the ion source 16 are subsequently converted to a crystalline AFt phase. In the embodiment of the invention illustrated in FIG. 1, the crystalline AFt phase is in the form of the AFt phase of ettringite 15. The ettringite is of the composition (CaO)₃(Al₂O₃)(CaSO₄)₃·32H₂O.

The AFt phase of ettringite 15 is formed from the aluminium hydroxide gel 11, the ions from the ion source 16 and the counterions from the counterion source 14 hydrate via a hydration mechanism. It is envisaged that the crystalline AFt phase may absorb a large amount of water from the body of water 12 such that the crystalline AFt phase 15 has a high water content. The AFt phase of ettringite 15 will have an elongate, or acicular, crystal structure.

Ions (and, in particular, calcium, aluminium and silicon ions) are extracted from the ion source 16 in order to drive the formation of the AFt phase of ettringite 15. Thus, the slag used as the ion source 16 is effectively a “mineable” resource as certain components of the slag may be extracted for use in the method of the present invention.

Environmental agents, such as carbon dioxide 17, are typically considered to be detrimental in the conventional Portland cement hydration process. However, in the method of the present invention, atmospheric carbon dioxide 17 may provide ions for use in the conversion of the aluminium hydroxide 13 to the AFt phase of ettringite 15.

Due to the amount of water 12 absorbed during the hydration process to form the AFt phase of ettringite 15, a reduction in the available water 12 assists in the conversion of the crystalline AFt phase 15 to the crystalline AFm phase 18. In some embodiments, the AFm phase may at least partially comprise gehlenite hydrate having the formula C₂ASH₈.

In FIG. 1, the mechanism of the formation of the crystalline AFm phase 18 includes the sequential replacement of elements within the crystalline AFt phase 15 and/or the counterions 14 and/or the ions 16.

The formation of the crystalline AFm phase 18 occurs within the frame structure or scaffold of the crystalline AFt phase 15. Developing a contiguous crystalline matrix within the AFt frame structure places the AFt frame structure under dehydrating conditions. In turn, this destabilises the AFt frame structure causing the AFt crystals 15 to decompose to their base raw materials, freeing them for their consumption by the ongoing AFm hydration process.

The AFm crystals 18 are, advantageously, environmentally stable, meaning that carbon dioxide 17 and salts 19 that are attracted to the hydration process do not react with the AFm crystals 18, and therefore no decomposition or degradation of the AFm crystals 18 occurs (unlike in the Portland cement hydration process).

Thus, not only is the hydration product of the present invention environmentally stable, but the crystal structure of the AFm phase 18 means that shrinkage of the AFm crystals 18 is reduced or eliminated, thereby providing a dimensionally stable product.

Further, not only is the method 10 of the present invention relatively fast in comparison to the conventional Portland cement hydration process, but the strength of the hydraulic binder (the AFm crystals 18 and/or residual AFt crystals 15) develops much faster than conventional Portland cements. Further, the compressive strength of a hydraulic binder produced according to the method of the present invention is greater than that of conventional hydraulic binders produced using Portland cement. Specifically, the 28 day compressive strength of hydraulic binders produced according to the method of the present invention is 2-2.5 times higher than the 28 day compressive strength of conventional hydraulic binders produced using Portland cement.

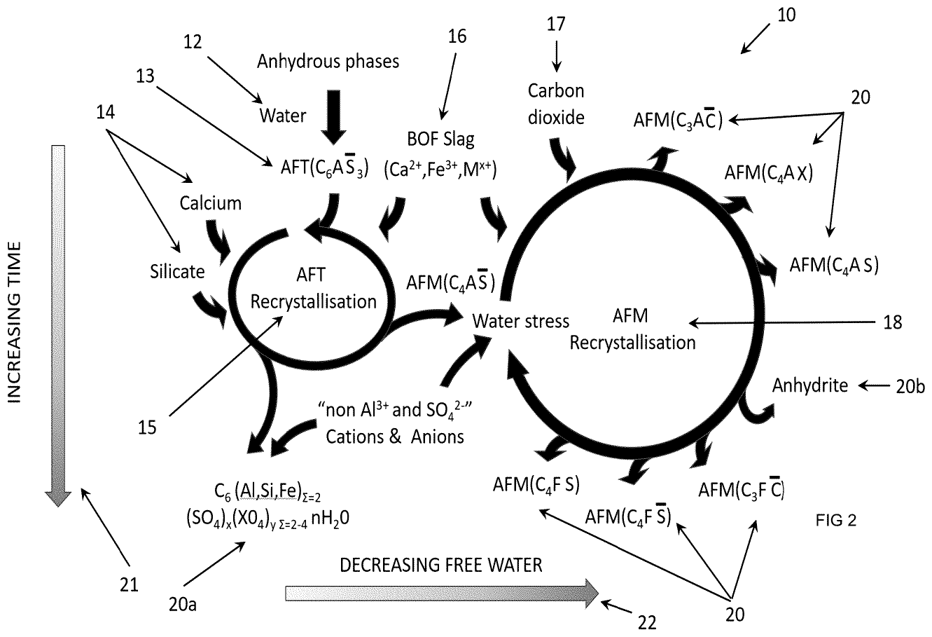

FIG. 2 illustrates a schematic representation of a method 10 for the production of a hydraulic binder 20 according to an embodiment of the present invention. In this Figure, counterions 14 produced from the counterion source and ions produced from the slag 16 react with aluminium hydroxide gel 13 formed in the body of water 12 to form the crystalline AFt phase 15. As reaction time (represented by arrow 21) increases, the conversion of the counterions 14 produced from the counterion source, the ions produced from the slag 16 and the aluminium hydroxide gel 13 continues. This reaction corresponds to a decrease in free water (represented by arrow 22) within the system, which in turn drives the conversion of the crystalline AFt phase 15 to a crystalline AFm 18 phase. The conversion of the crystalline AFt phase 15 to the crystalline AFm 18 phase is also driven by ions obtained from the slag 16 as well as carbon dioxide (such as atmospheric carbon dioxide).

As may be seen the hydraulic binder 20 comprises a plurality of forms of the crystalline AFm phase 18. It is envisaged that the hydraulic binder 20 may comprise the most chemically stable forms of AFm.

In the embodiment of the invention shown in FIG. 2, the hydraulic binder 20 also comprises a chemically stable form of the AFt phase 20a as well as one of more deposits of botryoidal anhydrite 20b.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for the production of a hydraulic binder comprising:
introducing a source of aluminium to a body of water to produce aluminium hydroxide;
introducing an ion source, in the form of a slag, to the body of water, the source configured to release a plurality of ions into the body of water;
introducing a counterion source to the body of water, the counterion source configured to release a plurality of counterions into the body of water;
converting at least a portion of the aluminium hydroxide at least a portion of the plurality of counterions and/or at least a portion of the plurality of ions to a crystalline AFt phase; and
converting at least a portion of the crystalline AFt phase using at least a portion of the plurality of ions to a crystalline AFm phase, wherein the crystalline AFm phase and/or the crystalline AFt phase forms the hydraulic binder.

2. A method according to claim 1 wherein a source of calcium is also introduced to the body of water.

3. A method according to claim 1 or claim 2 wherein the source of aluminium and the source of calcium comprise one or more water soluble ionic compounds.

4. A method according to claim 3 wherein the one or more water soluble ionic compounds comprise an aluminium calcium silicate, an aluminium calcium oxide, an aluminium calcium halide, an aluminium calcium hydroxide, an aluminium calcium chloride, an aluminium calcium sulfide, an aluminium calcium sulphate or a combination thereof.

5. A method according to any one of the preceding claims wherein the counterion source comprises one or more water soluble inorganic compounds.

6. A method according to any one of the preceding claims wherein the counterion source is a source of sodium, potassium, calcium, iron, aluminium, copper, nickel, strontium, chromium and/or zinc ions.

7. A method according to any one of the previous claims wherein the pH of the body of water is between 7 and 9.

8. A method according to any one of the previous claims wherein the aluminium hydroxide is produced as a precipitate of aluminium hydroxide gel.

9. A method according to any one of the previous claims wherein the at least a portion of the aluminium hydroxide and the at least a portion of the plurality of counterions are converted to the crystalline AFt phase via a hydration mechanism.

10. A method according to any one of the previous claims wherein the crystalline AFt phase has a acicular morphology.

11. A method according to any one of the previous claims wherein the crystalline AFt phase is in the form of the AFt phase of ettringite.

12. A method according to any one of the preceding claims wherein the slag comprises a steel slag.

13. A method according to claim 12 wherein the steel slag comprises a BOF slag.

14. A method according to any one of the preceding claims wherein the slag undergoes a size reduction process prior to being introduced to the body of water.

15. A method according to any one of the preceding claims wherein the slag is combined with a calcium sulphoaluminate cement or a calcium aluminate cement prior to being introduced to the body of water.

16. A method according to any one of the previous claims wherein the crystalline AFm phase comprises a combination of mono carbonate, mono sulphate and gehlenite hydrate.

17. A method according to any one of the previous claims wherein the crystalline AFm phase is formed by the sequential replacement of elements within the crystalline AFt phase and/or the counterions.

18. A method according to any one of the previous claims wherein the crystalline Aft phase forms a frame structure or scaffold on which the crystalline AFm phase forms.

19. A method according to claim 17 wherein the formation of the crystalline AFm phase occurs within the frame structure or scaffold such that the frame structure or scaffold is placed under dehydrating conditions causing the AFt crystals to decompose to their base materials for consumption in the formation of the crystalline AFm phase.

20. A method according to any one of the preceding claims wherein the hydraulic binder further comprises one or more anhydrite deposits.

21. A hydraulic binder when formed by the method according to any one of the preceding claims.
